(19) United States
(12) Patent Application Publication
(10) Pub. No.: US 2005/0019591 A1
(43) Pub. Date: Jan. 27, 2005

(54) Metallized films

(76) Inventor: Jean-Marc Francois, Longuyon (FR)

Correspondence Address: EXXONMOBIL CHEMICAL COMPANY, P O BOX 2149, BAYTOWN, TX, 77522-2149, US

(21) Appl. No.: 10/822,188

(22) Filed: Apr. 6, 2004

Related U.S. Application Data
(60) Provisional application No. 60/461,737, filed on Apr. 10, 2003.
(60) Provisional application No. 60/461,766, filed on Apr. 10, 2003.

(51) Int. Cl. B32B 15/08; B32B 27/00; B32B 1/00

(52) U.S. Cl. 428/458; 428/461; 428/336

(57) ABSTRACT

Metallized films having enhanced barrier properties consist of a first polymer layer, a barrier layer, and a metal layer coated with a heat seal and/or printable layer which has been transferred onto the metal layer.

### CROSS REFERENCE TO RELATED APPLICATION

This application claims benefit to U.S. Provisional application 60/461,737 filed on Apr. 10, 2003, and benefit to related U.S. Provisional application 60/461,766 filed on Apr. 10, 2003.

### FIELD OF THE INVENTION

This invention relates to the production of polymeric film structures, for instance, metallized barrier-type, oriented, polymeric films, which are especially, but not exclusively, useful for packaging of materials or labelling of articles, particularly articles benefiting from a reduced transmission of oxygen and/or water vapour or films requiring enhanced metallic appearance or special printing needs.

### BACKGROUND OF THE INVENTION

This invention relates to improved metallized plastic films, which are especially, but not exclusively, useful for packaging materials, particularly materials that have a reduced transmission of oxygen and/or water vapour. The invention also relates to intermediary products, which may be used in the production of such improved metallized plastic films.

It is well known to package materials in laminar or sheet-like plastic films or multi-layer plastic film laminates. Where the materials are sensitive to oxygen and/or water vapour (e.g., materials such as certain foodstuffs, beverages, chemicals, pharmaceuticals, seeds, electrical components, etc.), a plastic packaging material is chosen, which will provide a barrier against ingress of oxygen and/or water vapour, or other gases. It is also well known to package certain foodstuffs in an atmosphere of gas contained within a plastic material chosen for its low permeability to that gas (controlled atmosphere packaging or modified atmosphere packaging sometimes known as MAP).

It is also known to apply a gas-barrier layer, for instance, a thin layer of a metal such as aluminum, in order to improve the barrier of the film to oxygen, and other gases and/or to water vapour. Metallized films can be further laminated to a heat sealable film such as a polyolefin film (e.g., polyethylene or polypropylene) or they can be laminated to a polyester film, to produce a material suitable for packaging oxygen—or moisture-sensitive products. However, the gas and moisture barrier properties are not significantly improved by this lamination. It is also known to apply gas barrier layers, such as layers of ethylene vinyl alcohol copolymers or layers of polyvinylidene chloride.

For some applications it is desirable to decorate the package with, for example, print, and for reasons of security and integrity the printing material is frequently sandwiched between layers of the laminate. This can be achieved by printing the film and metallizing over the print before further conversion. These activities are typically performed by film converters who process films for supply to the ultimate users. This procedure can have the undesirable effect that the printed film becomes more permeable to oxygen and water vapour than the unprinted metallized film.

Metallized films are known to have low permeability to moisture but they have an undesirably high permeability to oxygen. Examples of such films include metallized polyolefin films, such as metallized mono-oriented or bi-axially oriented polypropylene film (hereafter OPP), metallized polyethylene film (hereafter PE), or metallized oriented polyester film (hereafter PET). Single webs of these films typically provide a moisture barrier of about 1 g/m²/24 hours (at 38° C. and 90% Relative Humidity). Laminates of such metallized polyolefin films to unmetallized films, suitable for packaging of moisture-sensitive materials, are described in GB Patent 1,566,925. However, gas and moisture barriers are not significantly improved by this lamination when compared with those of the single web metallized film. The clear web itself or the adhesive used for the lamination can, however, be chosen to impart good barrier properties.

In some applications it is desirable to decorate the package made from laminates of metallized and unmetallized films with, for example, print, and the print is often sandwiched between the layers of the laminate. This is normally achieved by printing the clear web and laminating it to the metallized polyolefin web. Gas and moisture barrier properties are not significantly improved over that of the single web metallized film unless the clear web itself or the ink or the adhesive has good barrier properties. The decorated package could also be produced by printing the clear polyolefin web, metallizing over the print, and then laminating to another clear polyolefin web, but this is not used commercially, the former process described above being preferred. By laminating a metallized polyolefin film to a further web of a metallized polyolefin film, further reductions in permeability can be achieved and a material with both good moisture barrier and good oxygen barrier is produced. European patent 154 428 A describes such laminates. The terms “coating” and “precoating” as used herein included the presence of laminar sheet elements in the film structure, as well as coatings applied as liquids, melts or solid granular additives. For example, an intermediate or external layer may be considered as a coating or precoating depending upon its use. Similarly the terms “coating” and “precoating” may also include tie layers or skin layers depending upon their intended use.

Polypropylene films with a coating on one or both sides and metallized on one of the coated surfaces are also known from, for example, U.S. Pat. No. 6,013,353. Such films are commercially available. When the coating is of a thermoplastic polymer resin that has no particular barrier properties, such as an acrylic resin, oxygen permeability of the unmetallized coated film is undesirably high (typically 500-1000 cc/m²/24 hours at 23° C. and 0% Relative Humidity) and oxygen permeability after metallization is also correspondingly high (greater than 10 cc/m²/24 hours at 23° C. and 0% Relative Humidity). When the coating is of a thermoplastic polymer resin with good barrier properties, such as a polyvinylidene chloride resin, oxygen permeability of the coated film is significantly reduced (typically 25 cc/m²/24 hours at 23° C. and 0% Relative Humidity) and oxygen permeability after metallization is correspondingly low (typically less than 5 cc/m²/24 hours at 23° C. and 0% Relative Humidity). Such films are widely used for packaging either in single web form or laminated to another unmetallized web. For applications where it is desirable to decorate the package with, for example, print, and to sandwich the print within a laminate, the unmetallized web is normally printed and then laminated to the metallized coated polypropylene web.

Current metallized films suffer from the disadvantages that scratches and folds in the metal, typically aluminum, layer can significantly decrease the water vapour barrier and gas barrier properties of the metallized films. Furthermore, the aluminum layer is difficult to print, and needs to be primed before printing usually by the converter. In addition, the aluminum layer is not sealable. A further disadvantage is that the unprotected aluminum layer is very sensitive to scratching and oxidation, which is detrimental to the optical quality and barrier properties of the film and for most applications the aluminum layer has to be protected by the converters with a varnish. U.S. Pat. No. 6,013,353 describes a process in which a coating is applied on top of the metal layer of a metallized film. The films of U.S. Pat. No. 6,013,353 are, however, described as having only moderate oxygen barrier properties.

It is known that thin aluminum layers such as those present in metallized films oxidize to some degree upon exposure to the atmosphere to produce aluminum oxide. It is also known that the presence of aluminum oxide in the aluminum layer is undesirable in that it is hygroscopic and reduces the barrier properties of the layer, thereby reducing the barrier protection to both oxygen and water vapour. Accordingly, in a process such as that described in U.S. Pat. No. 6,013,353, there can be significant oxidation of the aluminum layer.

### SUMMARY OF THE INVENTION

We have now developed a film that has improved barrier properties and may be used in unprinted form directly by the end user, usually the packager, without the need for additional conversion to provide a heat sealable or printable surface thereon.

We have also developed a process for the production of such a film, which forms the subject of a patent application co-filed on the same day as this application under Applicant's reference 2002B100. This process involves the transfer of a layer onto the metal layer of a film during film manufacture, preferably during winding or unwinding of the film in the metallizer. The present invention, therefore, also includes the intermediary film prior to transfer of the layer in such a process.

The films of the present invention can also replace some of the current laminates of two or more films by a monofilm or by a laminate having fewer layers but equivalent or better properties. The films according to this invention also have barrier properties comparable to earlier multi-layer films but with fewer layers and fewer manufacturing steps. Accordingly, manufacture is simplified and the associated costs reduced.

In one embodiment, the invention can provide a multi-layer structure comprising an aluminum layer that is protected by a protective “transfer” layer before the aluminum layer contacts any substantial amount of atmospheric oxygen. In such embodiment, the aluminum layer may undergo less oxidation than the degree of oxidation in a standard metallized film. Such reduced oxidation of the aluminum layer may result in an aluminum layer of higher purity, which provides better barrier properties for a given amount of aluminum deposited.

### DETAILED DESCRIPTION OF THE DRAWINGS

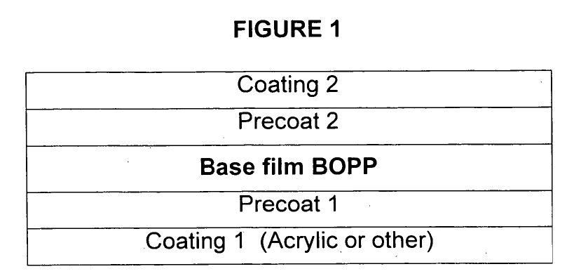

FIG. 1 illustrates a coated preliminary or initial film useful in preparing a multilayer film product according to this invention, wherein “Coating 2” may be considered a “transfer layer” as described below.

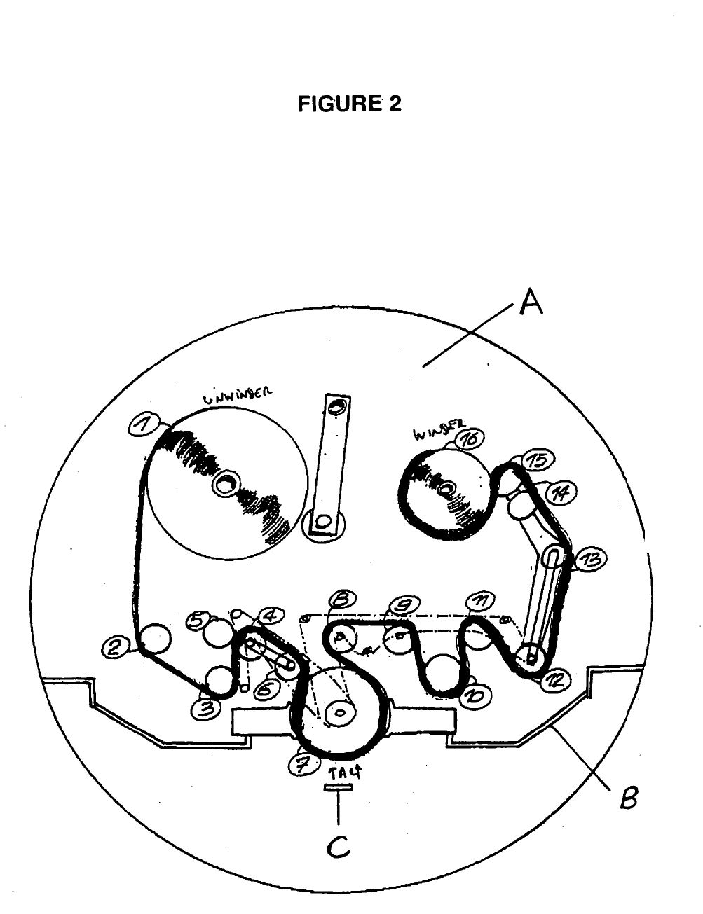

FIG. 2 illustrates a metallizer as may be typically used to apply a metal layer to the initial film, to produce an intermediate film substrate that is useful in preparing a multilayer film product according to this invention.

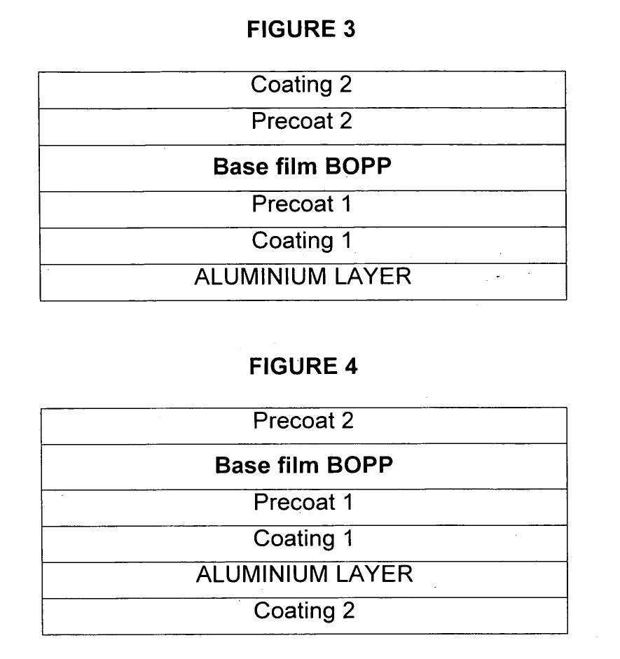

FIG. 3 illustrates an intermediate film product according to this invention that has been metallized.

FIG. 4 illustrates a multilayer film produced according to this invention, wherein the transfer layer is shown having been transferred from the initial side of the first layer and attached with the metal layer on the second side of the first layer. In this embodiment, the transfer layer is a coating layer, as opposed to a coextruded or laminated layer.

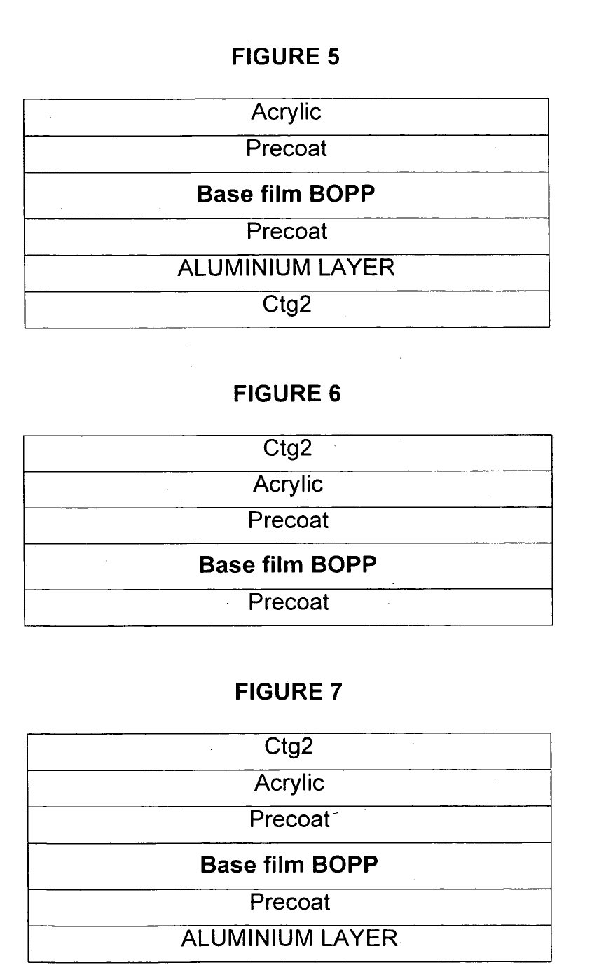

FIG. 5 illustrates a multilayer film embodiment according to this invention wherein the metal layer is applied on the first layer, and having the transfer layer previously transferred.

FIG. 6 illustrates an initial film, before metallization, as may be used in the production of the multilayer film illustrated in FIG. 5.

FIG. 7 illustrates an intermediate film substrate that may be the film of FIG. 6 after application of a metal layer.

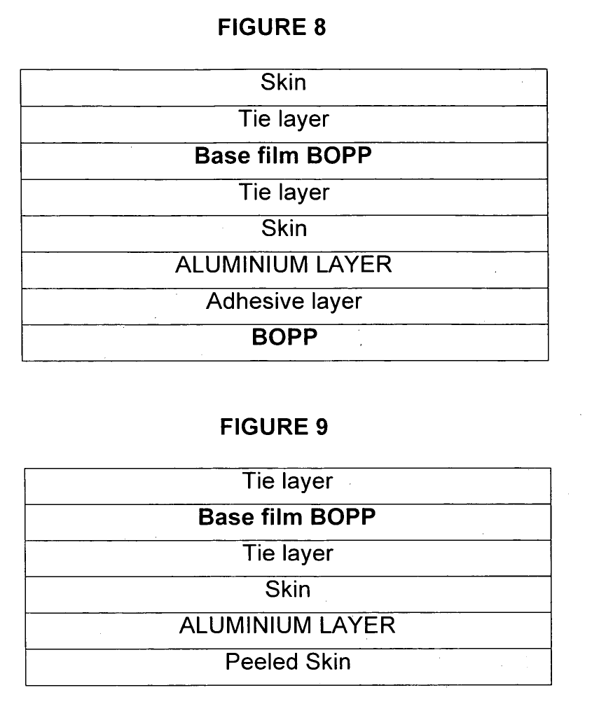

FIG. 8 illustrates a prior art laminated film as may have been prepared by prior art techniques.

FIG. 9 illustrates a film prepared according to this invention that may provide benefits equal to or superior to the performance of the film of FIG. 8.

### DETAILED DESCRIPTION OF THE INVENTION

Applicant's related application, filed contemporaneously with this application as Applicant's file number 2002B100, on the process of making a film according to this invention is incorporated herein by reference.

In one embodiment, the present invention, provides a film comprising a polymeric first/core layer(s) and a optionally, but preferably, polymeric second layer(s) on a first side of the core layer. If the second layer is present, the first side of said second layer, that is, the side opposite to said first layer supports a metal layer and if the second layer is not present, then the first side of the core first layer supports the second side of the metal layer. The first side of said metal layer opposite to said second layer contacts a transfer layer that was attached to the metal layer by transferring the transfer layer from its pre-transfer position on the second side of the core layer to the first side of the metal layer. The transferred layer is preferably a heat sealable layer, a barrier layer, and/or printable layer. As used herein, the term “barrier layer” is to be interpreted broadly to include layers used to reduce water, odor and or gas transmissibility properties of the film and also includes skin layers provided to improve film appearance, strength, structural integrity, and/or processiblity/machinability.

“Heat sealable” is a well known term in the films art and heat sealable, as used herein in relation to a surface of a film, means that the film may be made to adhere to another surface when held against the other surface under pressure and heat. The conditions to be used will depend upon the nature of the surfaces and the conditions to be used will be apparent to the skilled man. The term printable as used herein in relation to a surface of a film means that the surface is able to retain at least one type of printing. It does not mean that the surface must be able to retain all types of printing.

Though some embodiments may not comprise a second barrier layer between the first layer and the metal layer, post-transfer, the film structure of the present invention has reduced water-vapour transmission and/or reduced gas transmission properties due at least in part to the second polymeric barrier layer between the metal layer and the first layer, and due in part to the improved quality of the metal layer due to decreased oxygen contamination of the metal layer. The film also may have printability and sealability due to the sealable and/or printable third/transfer layer contacting the side of said metal layer opposite to said second polymeric barrier layer.

The first layer may be oriented or unoriented and is preferably an oriented layer and the polymer of the first layer of the film of this invention generally provides the mechanical properties considered necessary or desirable in the film. In many cases, the first layer comprises a polymer that is a polyolefin having a melting point, for example, of at least about 125° C. and up to, for example, about 190° C., and a relatively high degree of crystallinity. A particularly desirable polyolefin making up the first layer is an isotactic polypropylene homopolymer which is, for example, about 93% to 99% isotactic and has a crystallinity of from about 70% to 80% as measured by differential scanning calorimetry, and a melting point, for example, of about 145° C. or higher, e.g., up to about 167° C., it is particularly preferred that the first layer be or oriented polypropylene. In some embodiments, the first layer comprises multiple layers, such as a core and one or more skin or tie layers.

Another desirable polymer suitable for the first layer of the film of this invention is a high density polyethylene (HDPE), which is a substantially linear polymer having a density, for example, of from about 0.952 g/cc to 0.962 g/cc, a melting point of, for example, about 130° C. to 148° C. and a degree of crystallinity of at least 2%, preferably at least 15%. HDPE is particularly useful for the production of an oriented first layer.

Examples of polymers which may be used to produce an unoriented first layer include polyethylene, polypropylene, polyamide and polyesters which may be case to produce unoriented films. Calendared films of polyvinyl chloride may also be used.

If it is desired to produce a film which is opaque after being subjected to uniaxial or biaxial orientation as described hereinafter, opacifying particles or voiding agents, such as calcium carbonate or polybutylene terephthalate, may be dispersed in the polymer of the first oriented layer before extrusion and orientation of the film. As used herein, the term voiding agents is defined broadly to include all organic and inorganic particulate materials known and used in the films industry for voiding. The particle size of the particles may be, for example, about 0.1 to 10 microns, preferably about 0.75 to 2 microns. The voiding agents may be present in the first layer in an amount of up to about 20 wt. %, preferably about 6 wt. % to 12 wt. % based on the total weight of the first layer. To preserve the structural integrity of the void-containing first layer, a thin skin layer of polymer in the absence of void agents may be co-extruded on one or both sides of the void-containing first layer. In this case, the total of the void-containing polymer first orientated layer and the non-void-containing polymeric layers may be considered the overall first layer of the film. When the first polymer layer is subjected to uniaxial or biaxial orientation, a cavity forms around each microsphere giving the oriented film an opaque appearance.

An adjacent skin layer having a greater adhesiveness to other materials than the first oriented layer, optionally, may be provided on one or both sides of the first layer. The polymer of the optional skin layer adjacent to one or both surfaces of the first layer is preferably an extrudable hydrocarbon polymer such as a polyolefin having a lower melting point, e.g., at least about 5° C. lower and up to about 50° C. lower, than the melting point of the polymer of the first layer. Polymers falling within this category when the first polymer layer is an isotactic polypropylene homopolymer are, for example, isotactic copolymers of propylene and a minor amount, e.g., about 1 wt. % to 10 wt. %, of one or more different 1-olefins, e.g., ethylene or a higher 1-olefin having, for example, 4 to about 8 carbon atoms. Particularly suitable are isotactic copolymers of monomers consisting of propylene, ethylene in an amount of, for example, 1 wt. % to 5 wt. % of the copolymer, and, optionally, butene in an amount, for example, of about 0.5 wt. % to 10 wt. %, typically 0.5 wt. % to 5 wt. % of the copolymer. Other polymers which can be used for the skin layers of the film substrate when the first layer polymer is an is otactic polypropylene homopolymer are, for example, high density polyethylene (HDPE), and linear low density polyethylene (LLDPE). If the first oriented polymer layer is an HDPE, the polymer of the skin layers adjacent to the first oriented layer may be any of the polymers disclosed previously as suitable for such layers except for HDPE itself, as long as the polymer has the requisite lower melting point than the HDPE making up the first layer. In this connection, it should be noted that the polymers of the skin layers may be the same or different. For example, when the first polymer layer is a polypropylene homopolymer, the skin layer polymer may be a terpolymer of propylene, ethylene and butene on one surface of the first layer and HDPE on the other surface.

In one embodiment, the polymer substrate of the film of this invention comprises a first layer and optionally, one or two adjacent skin layers having a lower melting temperature than the first layer, preferably prepared by co-extruding the layers. After such extrusion, utilizing conventional extrusion techniques, the film is reheated and molecularly oriented in the longitudinal, i.e., machine, direction and, optionally, in the transverse direction. This uni-axial or bi-axial orientation, which greatly improves the stiffness and tensile strength properties of the film, is accomplished by utilizing conventional techniques to stretch sequentially the film, for example, about three to eight times in the machine direction and, optionally, five to twelve times in the transverse direction, at a drawing temperature of about 100° C. to 200° C. Alternatively, stretching may be simultaneous in the machine and transverse directions such as in blown tubular film production or by Linear Motor Simultaneous Stretching. In some cases, a co-extruded film having a first layer of polypropylene homopolymer would be bi-axially oriented, while a film having a first layer of LDPE may be substantially uni-axially oriented, i.e., primarily only in the machine direction, with relatively little to no transverse stretching.

The film according to this invention may also comprise a second layer which may be coextruded with the first layer or combined with the first layer, such as by extrusion lamination. In some embodiments, the second layer also functions as a barrier layer and can be a single layer or several layers. In some instances, tie layers or the skin layers may be utilized to improve the adhesion of the second layer with the first layer.

A metal layer is also included in films according to this invention. The metal layer is preferably an aluminum layer and preferably applied as a continuous layer in a vacuum deposition process. Before applying the metal, a primer or polymeric, film-forming coating, optionally may be applied to the surface intended to receive the metal coating. In addition to the metal receiving layer being treated, other layers may also be treated where it is beneficial to improve layer bonding. The surfaces may be treated to ensure that the layers will strongly adhere to the film substrate, thereby eliminating the possibility of the layers peeling or being stripped from the film, except where it is intended that one layer be transferred from one side of the film to the other. Such treatments to improve layer adhesiveness can be accomplished by employing known prior art techniques; for example, film chlorination, i.e., exposure of the film to gaseous chlorine, treatment with oxidizing agents, such as chromic acid, hot air or steam treatment, flame treatment, corona discharge treatment, and the like. In many embodiments, flame, plasma, or corona discharge treatment of the surfaces is preferred in the production of the films of this invention.

In addition, films according to this invention further comprise a transferrable or transfer layer positioned on one side of the first layer and a metal layer positioned on the other or opposite side of the first layer. The transfer layer is discussed in more detail later in this specification but generally, the transfer layer is formed substantially with the first and other layers, such as by co-extrusion, or subsequent to extrusion of the first layer, such as by lamination or coating. Such pre-metallized substrate structure may be referred to as a preliminary or initial film structure, as related to films of this invention.

A metal layer is applied to the preliminary multilayer film structure typically after the transfer layer, first layer, and other layers, are combined. The metallized structure, prior to transfer of the transfer layer, may be referred to as an intermediate or intermediary film substrate. After application of the metal layer, the transfer layer is transferred during a post-metallization winding and unwinding process, from the side of the first layer that the transfer layer is initially provided on, to the other side of the first layer, on the outer surface of the metal layer opposite the first layer. The transfer layer thereby functions to protect the metal layer from significant exposure to oxygen or atmosphere degradation during later post-transfer conversions, winding and unwinding. Another benefit of this process is that such protection is obtained substantially prior to any significant exposure of the metal layer to oxygen and obviates the need to perform a separate post-metallization coating step by a converter. This whole process is discussed in more detail below.

Referring to application of the metal layer to the preliminary structure, metallization may take place in a conventional metallizer, which consists of a chamber divided into two sections, both of which are atmosphere evacuated to a reduced pressure less than atmospheric pressure. A reel or roll of unmetallized film comprising the first layer and optionally the second layer and/or the other optional layers, such as the skin layer(s) is located in one of the two sections. The film to be metallized passes from the reel onto a roll which carries the film into the other section where metal, such as aluminum, is vaporized and deposited onto a surface of the film, such as a surface of the second layer, usually as the film passes around the roll. Typically the roll is cooled to between −15° C. and −35° C. After metallization, the metallized film passes back into the first section of the metallizer where the metallized film is wound into a roll or reel.

The thickness of the metal layer that is deposited in the metallizer should preferably be such that at its minimum thickness, it provides a substantially continuous layer and at its maximum thickness it has adequate adhesion to the substrate. Thickness of the relatively thin vacuum-deposited layers of metal is normally, and most conveniently, quoted in terms of their light transmission or optical density. For a gas-barrier layer made of aluminum, an optical density in the range of 1.0-4.0 may be preferred, with the range 1.8-3.5 being frequently preferred. Optical density is being measured by using a Gretag Macbeth D200-II machine, which directs a beam of light from a halogen lamp perpendicularly onto the film and measures the percentage of light that is transmitted by the film. Any metal, which on vacuum deposition provides a barrier layer may be satisfactory, with aluminum being typically preferred. When the gas-barrier layer is an aluminum layer, the thickness may be preferably between 5 and 500 nanometers.

In general, an uncoated and surface treated film substrate produced by co-extrusion and orientation may, optionally comprise one or more skin layers or second polymeric barrier layers that has a thickness, for example, of about 0.5 to 3.0 mils. Typically, where the first layer is provided with skin layers, the first layer has a thickness, for example, of about 80% to 99% of the total thickness of the first layer and the one or two adjacent skin layers each of which has a thickness of, for example, about 1% to 10% of the total thickness. If two skin layers are present, their thickness' may be the same or different. Application of a metal layer to a treated surface of the second barrier layer is usually accomplished by conventional vacuum deposition although other methods known in the art, such as electroplating or sputtering, foil embossing, or lamination may also be used. Aluminum is preferred as the metal utilized for this purpose although other metals similarly capable of being deposited, such as gold, zinc, copper, silver and others known in the art may also be utilized for certain purposes.

After metallization, the transfer layer is transferred from the non-metallized side of the first layer to the outer side of the metal layer, that is, on the side of the metal layer opposite from the first layer. The metal layer comprises a first side and a second side, the second side of the metal layer being positioned on but not necessarily immediately adjacent, the first side of the second layer or the first side of the first layer. In the final multilayer film product, the transfer layer comprises a debonded surface, which may typically be the exterior surface, and a metal-bonding surface, the metal bonding surface fixedly engaged on the first side of the metal layer, typically directly engaged with the metal layer. Preferably, the transfer layer has polar properties that enhance bonding between the transfer layer and the metal layer. The de-bonded/detached surface comprises optical and aesthetic qualities suitable or desirable for the desired application for use of the final multilayer film product. The appearance or optical performance of the debonded surface of the transfer layer is broadly adjustable depending upon the type of layer that the transfer layer is, e.g., seal layer, print layer, or barrier layer. The mix or composition of materials and/or additives provided within the transfer layer will dictate the features and performance of the debonded surface, the metal bonding layer and of the transfer layer on whole.

In the initial or pre-metallization film structure, the transfer layer was formed or applied subsequent to extrusion of the first layer, on the second side of the first layer, wherein the de-bonded/detached surface of the transfer layer was removably bonded/attached on the second side of the first layer. After metallization, the transfer layer was transferred to and fixedly engaged on the first side of the metal layer opposite to the second layer upon winding the film on a roll after the metal layer is applied to the second layer. The transfer layer generally comprises at least one of a heat sealable layer, a barrier layer and/or a printable layer. The debonded/detached surface of the transfer layer thereafter typically comprises an exterior surface of the film and is also at least one of printable, sealable, and optionally may be laminated with another polymeric substrate. As stated previously, the appearance and/or performance of the debonded surface may be tailored by one skilled in the art, using techniques and additives known in the art to provide a desired optical performance, appearance, or functional effect, such as sealability gloss, matte, opacity, barrier properties, etc. What is important is that the transfer layer is capable of removably or detatchably bonding in the initial or intermediate film structures, on the second side of the first layer, and can thereafter, after metallization and post-metallization rewinding, fixedly bond with the metal layer or on an exterior side of the metal layer to thereafter detatch or de-bond from the second side of the first layer when the metallized, rolled multilayer film is unwound, thus facilitating transfer of the transfer layer and formation of the final film product.

The heat sealable and/or printable layer can be made with a polymer material, water-based, solvent-based or solventless thermoplastic lacquers, or inks based on resins. It may be preferred the transfer layer comprise a polymer containing polar groups which have an affinity for the metal layer. Examples of preferred materials include copolymers of ethylene and unsaturated esters such as vinyl esters, for example, vinyl acetate or vinyl propionate and acrylic esters, such as methyl acrylate, ethyl acrylate or butyl acrylate. Copolymers of ethylene and unsaturated alcohols such as vinyl alcohol may also be used. However, it may be preferred that the layer contain carboxylic acid groups and copolymers of ethylene and acrylic acid and/or methacrylic acid. A preferred heat sealable layer comprises a low temperature sealable coating which can be applied to the metallized surface of the film without a primer, a preferred such coating comprises a base copolymer of about 10 wt. % to 35 wt. % of an alpha, beta-ethylenically unsaturated carboxylic acid, with about 65 wt. % to 90 wt. % of ethylene, or an alkyl acrylate or methacrylate, acrylonitrile, or mixtures thereof The latter unsaturated acid may be, for example, acrylic acid, methacrylic acid, maleic acid, crotonic acid, itaconic acid, citraconic acid, or mixtures thereof Preferably, the copolymer is of about 65 wt. % to 90 wt. %, more preferably about 75 wt. % to 85 wt. % of ethylene, and about 10 wt. % to 35 wt. %, preferably about 15 wt. % to 25 wt. % of acrylic acid (an EAA copolymer) or methacrylic acid (an EMA copolymer). The copolymer, preferably, has a number average molecular weight (Mn) of, for example, about 2,000 to 50,000, preferably about 4,000 to 10,000.

The carboxylic acid copolymer in the preferred low temperature sealable coating applied to the metallized surface is often obtained as a solution or fine dispersion of an ammonium salt of the copolymer in an ammoniacal water solution. When the copolymer is dried, ammonia is given off and the ionized and water sensitive carboxylate groups are converted to largely unionized and less water sensitive free carboxyl groups. In another embodiment, however, there may be added to the solution or dispersion of the ethylene copolymer an amount of ions of at least one metal from Group Ia, IIa, or IIb of the Periodic Table, preferably, sodium, potassium, lithium, calcium or zinc ions, and most preferably sodium ions, e.g., in the form of their hydroxides. The quantity of such metallic ions may be in the range sufficient to neutralize, for example, about 2% to 80%, preferably about 10% to 50% of the total carboxylate groups in the copolymer. The presence of such metallic ions has been found in many cases to result in an improvement in certain properties, e.g., coefficient of friction (COF), hot tack, and blocking, without an unacceptable sacrifice of other properties, e.g., low minimum seal temperatures (MST).

When the base copolymer in the sealable coating applied to the metallized surface is an EAA copolymer of 80 wt. % of ethylene and 20 wt. % of acrylic acid and the neutralizing metal ions are sodium ions added as sodium hydroxide, then the amount of sodium hydroxide added corresponding to the foregoing percentages of carboxylate groups neutralized, may be, for example, about 0.33 phr to 8.8 phr, preferably about 1.1 phr to 5.5 phr, where “phr” stands for parts by weight per hundred parts of the total resin, which is the same as the EAA copolymer when no other resin is present. For the purpose of determining the phr of various additives present in the coating, all the carboxylate groups of the ethylene copolymer are assumed to be in their free carboxyl (—COOH) form.

In addition to the carboxylic acid-containing base copolymer, the sealable coating applied to the metallized surface may also contain a dispersed wax, e.g., a relatively large particle size carnauba or microcrystalline wax as an anti-blocking agent. Other waxes which may be used are, for example, natural waxes such as paraffin wax, beeswax, japan wax, montan wax, etc., and synthetic waxes such as hydrogenated castor oil, chlorinated hydrocarbon waxes, long chain fatty acid amides, etc. The wax may be present in the coating in an amount of, for example, about 2 phr to 12 phr, preferably about 3 phr to 5 phr.

In addition to functioning as an anti-blocking material, the wax, when incorporated into the coatings also functions to improve the “cold-slip” properties of the films coated therewith, i.e., the ability of a film to satisfactorily slide across surfaces at about room temperature.

The sealable coating applied to the metallized surface of the film may also contain a particulate material, e.g., an amorphous silica, for the purpose of further reducing the tack of the coating at room temperature. Amorphous silica is composed of particles which are agglomerations of smaller particles and which have an average particle size of, for example, about 2 to 9 microns, preferably about 3 to 5 microns, and may be present in the sealable coating in an amount, for example, of about 0.1 phr to 2.0 phr, preferably about 0.2 phr to 0.4 phr.

Other optional additives, which may be included in the sealable coating applied to the metallized surface of the film, include other particulate materials such as talc, which may be present in an amount, for example, of about 0 phr to 2 phr, cross-linking agents such as melamine formaldehyde resins, which may be present in an amount, for example, of 0 phr to 20 phr, and anti-static agents, such as poly(oxyethylene) sorbitan monooleate, which may be present in an amount, for example, of about 0 phr to 6 phr. An anti-bacterial agent may also be present.

In addition to the low temperature sealable coating on the metallized surface of the film, as previously described, a polymeric, film-forming coating may, optionally, be applied to the surface of the first layer opposite the metal layer. To ensure adherence of such coating to such opposite surface of the film substrate, a coating of primer may be first applied to such surface, either after the skin layer on such surface is treated to increase further its adhesiveness to other materials, e.g., by corona discharge, plasma or flame treating, or in the absence of such treatment: Primer materials which are suitable are well known in the art and include, for example, titanates, poly(ethylene imine), and reaction products of an epoxy resin and an aminoethylated vinyl polymer. The primer is applied to the treated surface of the film substrate by conventional solution coating means. A particularly effective primer is poly(ethylene imine) applied as either an aqueous or organic solvent, e.g., ethanol, solution, or as a solution in a mixture of water and organic solvent, containing about 0.5 wt. % of the imine.

The coating applied to the optionally primed surface of the first layer opposite the metallized surface may be a sealable coating of the same type as that on to the metallized surface or it may be any of other types of polymeric, film-forming coatings known in the art. A particularly suitable coating is one containing as a film-forming component an interpolymer of 1) about 18 wt. % to 80 wt. % of at least one C₁-C₄ alkyl methacrylate, 2) about 18 wt. % to 80 wt. % of at least one C₁-C₄ alkyl acrylate, and 3) about 1 wt. % to 15 wt. % of at least one alpha, beta-ethylenically unsaturated carboxylic acid based on the weight of the polymer (an “acrylic terpolymer”); and colloidal silica as a hot slip agent in an amount, for example, of about 30 phr to 60 phr and having a particle size of, for example, about 10 to 200 millimicrons. The unsaturated acid of the acrylic terpolymer may be any of those disclosed previously as suitable for the copolymer in the low temperature sealable coating applied to the metallized surface of the film, although acrylic and/or methacrylic acid are preferred. The copolymer may be utilized in the coating composition as a partially neutralized aqueous solution or as a dispersion, i.e., a latex. Additives may be present in the coating compositions which are the same or similar in nature and amount as those disclosed previously as suitable in the low temperature sealable coating applied to the metallized surface of the film, particularly a wax such as carnauba wax, which functions as an anti-blocking and cold slip agent, and talc, which acts as a lubricant. This type of composition is disclosed, for example, in U.S. Pat. Nos. 3,753,769 and 4,749,616.

Another type of polymeric coating which may be applied to the surface of the first layer opposite the metallized surface, optionally in conjunction with a primer, is a coating of a polymer of at least about 50 wt. % of vinylidene chloride, preferably about 75 wt. % to 92 wt. % of vinylidene chloride, 2 wt. % to 6 wt. % of an alpha, beta-ethylenically unsaturated acid such as any of those disclosed previously as suitable for the copolymers in sealable coatings and the remainder, a C₁-C₄ alkyl acrylate or methacrylate, or acrylonitrile. Additives, the same or similar to those disclosed previously in other coatings, may also be present in these coatings. The vinylidene chloride copolymer may be utilized as a partially neutralized aqueous solution or as an aqueous dispersion, i.e., a latex. This type of coating is disclosed, for example, in U.S. Pat. No. 4,944,990. This coating may be applied, optionally, in conjunction with a primer.

The transfer layer composition can be applied to the surface of the metal layer, or, if used, the primer. Polymeric coatings can be applied to the opposite surface. The coatings may be applied in any suitable manner such as by gravure coating, roll coating, dipping, spraying, etc. Where an aqueous solution is used, any excess aqueous solution can be removed by squeeze rolls, doctor knives, etc. The coating compositions will ordinarily be applied in such an amount that there will be deposited following drying, a smooth, evenly distributed layer of from about 0.2 to about 1 g/1000 sq. in. of film surface. In general, the thickness of the applied low temperature sealable coating is such that it is sufficient to impart the desired sealability, coefficient of friction (COF), and hot slip characteristics to the substrate polymer film.

The coatings, once applied, are subsequently dried by hot air, radiant heat, or by any other suitable means thereby providing a non-water soluble, adherent, glossy coated film product useful, for example, as a packaging film.

In one embodiment, the films of the present invention may be made by a process in which the transfer layer is transferred to the surface of the metal layer from the side of the first layer opposite the side of the first layer having the metal layer thereon. Such a process is described in a patent application co-filed on the same day as this application under Applicant's reference 2002B100. Transfer layers of the type described above can be provided initially on the surface of the layer of the film remote from the metal layer and that they can be transferred from that inintial side of the film to the opposite side on the surface of the metal layer. It is preferred that such transfer take place during winding or unwinding of the metallized film in the metallizer so that transfer occurs before the metal layer undergoes significant exposure to oxygen. In this way, oxidation of the metal layer can be largely avoided leading to improved barrier properties. Where the film contains additional layers on the side of the first layer remote from the metal layer, the transfer layer to be transferred should be the outermost layer on that side.

The present invention, therefore, further provides an intermediary film which can be used to produce the films of this invention previously described by such a transfer process. The intermediary film may comprise a first polymeric layer having a first side and a second side, a transferable transfer layer having a first side and a second side, the first side of the transferable layer being detachably engaged on the second side of the first polymer layer; and a metallized layer having a first side and a second side, the second side of the metallized layer being fixedly engaged with the film on the first side of the first polymer layer.

The intermediary films may also contain other layers such as the primers, skin layers, barrier layers and transfer layers previously described in relation to the final films of the present invention. The materials used for the layers and the relative juxtaposition of the layers may be as described above providing that the transferable layer is the outermost material on the second side of the first polymeric layer and the metallized layer is the outermost layer on the first side of the first oriented polymeric layer. It is particularly preferred that a polymeric barrier layer be provided between the first polymeric layer and the metallized layer.

A printed ink pattern may be applied on either surface of the film, or to the uncoated surface opposite the metal layer if no coating is applied to such opposite surface, using, for example, a conventional solvent-based ink composition. The printed pattern may be covered with an over-lacquer to protect the pattern from damage. The over-lacquer may cover the entire surface containing the printed pattern, in which case sealing is accomplished solely by the softening of the coating or a polymer skin layer on the opposite surface of the film on the portion of the film constituting the outer film of the seal. However, if an “in to out” seal is also desired, wherein sealing is also accomplished by the softening of the coating or polymer skin layer on the surface containing the printed ink pattern, a portion of which constitutes the inner film of the seal, then the printing and over-lacquering may be in a pattern to allow the coating or polymer skin layer to be exposed in the sealing region.

Optionally, another film (the “laminating film”) may be laminated to a surface of the metallized film of this invention for the purpose of improving the mechanical properties, e.g., tear strength, and machinability, increasing the stiffness, protecting the printed pattern and/or providing hermetic seals of the metallized film. An over-lacquer may or may not be applied. The laminating film may be bonded to the sealable coating on either the metal layer surface or the opposite surface of the film of this invention, either after a printed pattern has been applied to the sealable coating or in the absence of such printed pattern, or the bonding of the laminated film may be to said opposite surface in the absence of any sealable coating. The film may, for example, comprise a polymer having superior mechanical properties, e.g., isotactic polypropylene homopolymer, which is bonded to the film of the invention, such as by an adhesive, molten polymer having a lower melting point than the laminating polymer, e.g., low density polyethylene (LDPE). Alternatively, the laminating film may comprise a major layer of such polymer of superior mechanical properties and a minor layer of a polymer having a lower melting temperature than the polymer of the major layer with the lamination being accomplished by pressing the surface of the laminating film containing such minor layer against the desired surface of the metallized film of the invention at a temperature high enough to render tacky the polymer of the minor layer. The methods and equipment necessary to accomplish the described bonding are well known in the art.

An actinic radiation or an ionizing radiation or a combination of actinic and ionizing radiation can be applied on the whole surface or only on selected areas of the film, for instance, in order to crosslink a layer or in order to surface treat to increase the anchorage at a particular interface between two layers.

The printable and/or sealable layer adjacent the surface of the metal layer may be sealable on the side opposite the side adjacent the metal layer and may be printable on the side adjacent or opposite the metal layer. If the layer is provided by the transfer technique previously described, the surface that is exposed due to the transfer of the third layer may also be printable and/or sealable so that the multi-layer films can be printable and/or sealable on both sides. This enables the films to be used on packaging machines without any additional work by the converters who have traditionally applied additional printable and/or sealable layers to produce the ultimate packaging material. Accordingly, in a further preferred embodiment, the intermediary film contains a sealable and/or printable layer fixedly engaged to the first polymeric layer and detachably engaged to the transferable layer.

The films of the present invention are particularly useful as packaging materials. They are especially, but not exclusively, useful for packaging of materials sensitive to oxygen and/or water vapour or for controlled or modified atmosphere packaging of foodstuffs. They can be used in many other applications, for instance in labels, graphic art and in construction. Furthermore, in the films of the invention, the metal layer is sandwiched between two polymeric coatings having visco-elastic properties especially designed to avoid the formation of cracks in the metal layer when the film is folded. This avoids the loss of barrier properties due to such cracks.

Typical thickness' of the films and coating densities where the first layer is oriented polypropylene film and the films are produced according to the present invention may be that the first oriented polypropylene layer is of thickness from 15 to 60 microns. Metal, particularly aluminum layers, may be from 5 to 500 nanometers thick. Any precoats that are used may be typically present at from 0.1 to 1 gram per square meter and coatings such as heat seal and/or printable coatings or barrier coatings are present at from 0.1 to 5 grams per square meter.

The preferred process for the manufacture of certain film embodiments according to the present invention, may be illustrated in relation to a three-step process.

The first step comprises production of a coated film comprising a first oriented layer of polypropylene (corona treated on both sides), which may be coated with a precoat and a topcoat on both sides as is illustrated in FIG. 1. Precoat 2 may be of a compound that decreases the physico-chemical interactions at the interface between the precoat 2 and the coating 2 as compared with the interaction between precoat 2 and the first oriented layer of polypropylene. Preferably, the precoat 2 comprises a compound that bonds strongly with the corona-treated surface of the first layer of oriented polypropylene, but does not bond strongly with the coating 2. On the other hand, coating 1 may be a barrier material such as an ethylene vinyl alcohol copolymer and is chosen so that coating 1 is well anchored onto precoat 1 and similarly the material of precoat 1 is chosen so that precoat 1 is well anchored onto the base polypropylene film. Preferred materials for the precoats are polyethylene imines.

In a preferred embodiment of the invention, a modified corona treatment may be used in order to have a better anchorage of the precoat(s) on the polypropylene film. In yet another embodiment, a compound having a high affinity for the aluminum may be added into the material used for coating 2.

Coating 2 of the film illustrated in FIG. 1 may preferably be a standard low temperature sealing composition such as those described in U.S. Pat. Nos. 5,419,960 and 6,013,353 and is hereafter referred to as Ctg2. Ctg2 is the layer material after drying a 15 wt. % solid aqueous dispersion or solution of an ammonium salt of a copolymer of ethylene and acrylic acid, containing 1.5 phr (parts by weight per hundred parts of the dry copolymer) of sodium hydroxide (NaOH), together with fillers and anti-foam.

In the second step, the coated film produced in step one is metallized, generally with aluminum on the surface of the barrier material (coating 1). This may be accomplished by use of a standard metallizer, which may involve plasma or radiation treatment in the metallizer. The aim of the optional irradiation is to increase the physico-chemical interactions at one or several polymer/metal or polymer/polymer interface(s).

A typical metallizer is illustrated in FIG. 2, which illustrates the metallizer chamber (A) divided into two sections by barrier (B). The reel of unmetallized film (1) is mounted in the upper section of the metallizer and the film is fed by a series of guide rolls (2 to 6) to the process reel 7. The process reel bridges the two sections of the metallizer (both of which are under reduced pressure and are substantially oxygen free). The process reel 7 carries the film into the second section of the metallizer in which metal, usually aluminum, is deposited onto the film by vaporization of the metal by heating the aluminum wire (C) to around 1,450° C. The metal is deposited onto the film to provide a metal layer which is consolidated on the cold process reel 7 which is held at between −15° C. and −35° C. The metallized film, which is an intermediary film according to this invention, then passes via a further series of rollers (8 to 15) to the winder reel 16. The film is-wound on winder reel 16 so that the metal layer lies against the coating layer 2 (see FIG. 1). The metallized film produced in the metallizer at process reel 7 from the film of FIG. 1 is shown in FIG. 3 which illustrates an intermediary film according to the present invention.

The third step in the process involves the transfer of Ctg2 onto the metal layer to form a film of the present invention as shown in FIG. 4. The Ctg2 is in direct contact with the aluminum and with the precoat 2 and the physico-chemical interactions at the interface between Ctg2 and the surface of the adjacent aluminum layer are significantly higher than the physico-chemical interactions at the interface between Ctg2 and precoat 2. The Ctg2, therefore, becomes bonded to or fixedly engaged with the aluminum layer due to the forces which press the layers together during winding on the winder reel 16 and/or unwinding from the winder reel 16, such as during slitting. Bonding may be further enhanced, such as by adjusting the temperature of the wind roll and/or by the application of force by, for example, the provision of a roller bearing against the outer surface of the rewind roll. In order to control the transfer of Ctg2, the following parameters should be controlled: Physico-chemical interactions at all polymer/polymer and polymer/metal-layer interfaces; the angle of winding and unwinding at the winder reel; the speed of winding and unwinding at the winder reel; the temperature of the film on the rewind roll 16; the visco-elastic properties of Ctg2, coating 1 and precoat 2; and the thickness of coating 1 and Ctg2. These properties should all be selected according to the properties of the various film elements and the desired final film parameters to ensure proper bonding and transfer of the transferable layer Ctg2. For many typical film embodiments we have found that the transfer of the transferable layer may be enhanced if the temperature of the process reel (7) is increased from the traditional range of −15° C. to −35° C. to a temperature in the range 10° C. to 30° C. Alternatively, the temperature of the process reel in the metallizer may be maintained between −15° C. and −35° C. and the reel may be heated to between 10° C. to 30° C. after metallization but before unwinding, for instance, with an infrared heater.

Subsequent to winding of the metallized film onto the re-wind roll 16, as is illustrated in FIG. 3, facilitating the bonding of Ctg2 onto the adjacent metal layer, the film may be unwound from the re-wind roll. The unwound film will be structured with Ctg2 separated from precoat 2 and fixedly bonded with the metal layer as illustrated in FIG. 4. In this way the metallized layer is substantially, not directly, exposed to any atmospheric oxygen outside the confines of the metallizer chamber.

The process may be used to produce a variety of film structures. The structures may be produced by a process that comprises applying a precoat onto each side of a polypropylene film and then applying a top coating on each of the precoats. The coated polypropylene film is then metallized on one side and the remote top coating on the non-metallized side is then transferred onto the surface of the metal layer. The process is the same transfer-coating process as the one described previously, but with a turning device for film structure. For all the structures discussed, the thickness' are only indicative. The scope of the invention is not limited by the thickness or the drawings, which are merely illustrative of particular film embodiments according to this invention.

The use of a metallizable coating which is, for instance, an acrylic based polymer, provides improved barriers after metallization. In a preferred embodiment, an ethylene vinyl alcohol copolymer may be used as the second polymeric barrier layer.

FIG. 5 illustrates a metallized film according to the present invention that is printable and sealable on both sides. The film is produced in the following three steps; base film orientation, one pass coating with inverted band followed by metallization, and transfer.

To produce the film illustrated in FIG. 5, a precoat layer of polyethylene imine is first applied to one side of oriented polypropylene film and then dried. Using a first coating station, an acrylic coating is then applied to the precoated side of the film and dried in an oven. The film is then inverted on a turning bar and, using a second coating station, Ctg2 is detachably applied on top of the acrylic coating as illustrated on FIG. 6, Ctg2 is then dried. The film is then metallized on the side remote from Ctg2 to produce an intermediary film according to the present invention as shown in FIG. 7. After metallization, Ctg2 is transferred onto the aluminum, typically on the winding reel in the metallizer, or after metallization by heating the reel before unwinding to produce the film of the invention illustrated in FIG. 5 upon unwinding. The test on the pilot coater demonstrated a peeling force (160° to 180° angle) for the transfer of Ctg2 of around 0.20 mm to 0.25 N/25 mm at 300 mm/min. for a film based on an acrylic precoat overcoated with Ctg2. This was determined to be repeatable on a larger scale on an industrial production coater.

FIGS. 5 to 7, therefore, illustrate the production of both an intermediary film of the present invention and also a metallized film that is printable and/or sealable on both sides according to the present invention. The preferred final film is printable and/or sealable on both sides since, initially, the film had two layers of sealable and/or printable material on the side remote from the metal layer, and one of those layers has been transferred onto the metal layer and is now on the opposite side of the film to where it was originally. The film can be manufactured on existing production lines using standard equipment for orientation, coating, and metallizing. When the film of FIG. 6 is wound in the reel, the detachable Ctg2 is in direct contact with the aluminum in the reel. During winding or unwinding the reel, Ctg2 is transferred onto the metal layer and becomes well anchored to the metal. The transferable layer will transfer because it has a strong physico-chemical affinity for the metal layer and is such that it will anchor strongly to the metal layer. Accordingly, the transferable layer preferably contains polar groups which will “bond” to the metal. Carboxylic acid groups are preferred and copolymers of ethylene and acrylic acid and methacrylic acid have been found to be particularly suitable.

The use of the transfer of a coating layer onto the metal layer during reeling in the metallizer, to produce the films of the present invention, has the advantage that the aluminum layer is protected from oxidation and from scratches during subsequent processing because the metal is protected before it leaves the metallizer by transfer of a layer onto the aluminum layer by transfer of a coating. Furthermore, since the metallizer itself is substantially oxygen free, the exposure of the metal layer to oxygen is reduced and hence the likelihood of oxidation of the metal layer is reduced. Alternatively, the coating can be transferred onto the metal layer outside of the metallizer, for instance, by heating the reel before unwinding. Barrier properties are also improved compared to standard metallized films perhaps because of the increased purity of the metal film. The presence of the protective layer on the metal layer also improves the resistance of the metal layer under humid conditions by providing physical and chemical protection. In addition, by appropriate choice of materials, the film can be printable and/or sealable on either or both sides, and can therefore be used as such on packaging machines, without the need for additional processing by converters. The transfer coating process can also avoid the need for adhesive layers between the layers of multi-layer metallized films.

In standard metallized film based on aluminum, the aluminum layer tends to oxidize. When the films of the present invention are made by the preferred process, in which transfer occurs in the metallizer, the aluminum layer is protected by Ctg2 before the metallized film leaves the metallizer or is unwound. This reduced oxidation provides better barrier properties for the same deposit of aluminum per square meter, the protective layer provides better barrier resistance to humidity and better resistance to chemicals.

The films of the present invention can replace current, unprinted laminated films, such as the 20-micron bi-axially oriented polypropylene film/metal layer/adhesive layer/20-micron bi-axially oriented polypropylene film currently used commercially. These prior art films are currently produced by adhesive lamination of two, 20-micron bi-axially oriented polypropylene films, one of which is metallized.

FIG. 8 illustrates a prior art laminated film that may consist of a 20-micron layer of oriented polypropylene film laminated to a metallized 20-micron layer of polypropylene film. FIG. 9 illustrates a comparable film prepared according to the present invention. The tie layers are optional. Comparison of the films of these two Figures demonstrates that by using the transfer technique previously described, the invention can remove the need for an adhesive layer. The advantages of the structure of the present invention include the presence of the second barrier layer, the integrity of the metal layer and the transferred layer on the metal, which provides sealability and/or printability. We have also found that the packaging weight can be decreased by as much as 25% for the 30 g/m2 structure because of the ability to use a monofilm thinner than a laminate and the possibility to avoid the use of adhesives.

The metallized films of the present invention have improved barrier properties and can be used as a base material for pressure-sensitive laminates such as may be used in labelling applications. In addition, when the films are made by the new transfer process, the film from which labels are manufactured will have fewer scratches because the metal is protected before it leaves the metallizer without the need for subsequent lamination or coating a protective layer onto the metal layer. The film will have an improved appearance since only the defects of the coating are visible, unlike with standard films where the defects of two coatings, the metal layer and of the film may be visible. In addition, there is a reduced risk of metal scratching at the label manufacturer because there will be no direct contact between metal and adhesives. Furthermore, in current systems that employ the acrylic polymer based adhesives (especially the water-based ones) the acrylic can dissolve the aluminum layer and the dissolution of aluminum ions into the adhesive can cross-link the adhesive and decrease the properties of the pressure-sensitive adhesive. This is avoided by the films produced by the preferred process wherein the metal layer is protected.

The films of the present invention may also have some improved utility, e.g., as insulators and in construction, such as for covering windows where they may provide some protection against the sun. The invention also allows the production of a bi-axially oriented polypropylene film with a metallized layer covered by an ionomer, the ionomer being made by the reaction between the aluminum layer and the coated layer, for example, if the coated layer is an ethylene/acrylic acid copolymer.

The invention is illustrated by the following Examples.

In these examples the following test methods were used;

The adhesion between layers was measured using a Friction Peel Tester Model 225-1 made by Thwing Albert Instrument Company, Pa., USA by applying 25 mm wide adhesive tape to the surface of the film and measuring the average force in Newtons required to remove 10 centimeters of the tape with the coating from the film when pulled back at 300 mm/min. the angle between the tape and the film being comprised between 170° and 180°.

The optical density of the film was measured on a Gretag Macbeth D200-II machine by shining a beam from a halogen lamp perpendicularly onto the film and measuring the amount of light transmitted.

The permeability of the film to oxygen was measured in cc/m²/day according to ASTM D3985 at 23° C. and 0% relative humidity using an Oxtran 2/20 device made by Mocon 7500 Boone Avenue North, Minneapolis Minn. 55428 USA.

The permeability of the film to water vapour (WVTR) was measured in g/m² per 24 hours according to DIN 53380 at 23° C. and 75% relative humidity using a Permatran W 3/31 device also supplied by Mocon.

### EXAMPLE

A film was produced which consisted of a cavitated 35 micron first oriented polypropylene film layer provided on one side with a co-extruded skin of a propylene, ethylene, butene terpolymer that had been corona discharge treated and on the other side with a layer of polypropylene grafted with maleic anhydride and a second polymeric barrier layer of a copolymer of ethylene and vinyl alcohol. The co-extruded skin was then coated with about 1.5 g/m² (dried) of the previously described low temperature sealing composition Ctg2.

The film was fed to a standard metallizer (as illustrated in FIG. 2) where metal was deposited on the surface of the ethylene vinyl alcohol copolymer under the following conditions to produce an intermediary film according to the present invention.

The metallizer was first evacuated for a period of 11 minutes. The temperature of the process reel (7) was set at −20° C. to −30° C. The web was then unwound at 346 meters per minute. The traction in the unwind was 300 Newtons/m and the traction in the winder was 45 Newtons/m. Aluminum wire was supplied to the crucible in the metallization chamber at a rate of 51 cm/minute, the pressure in the metallization chamber was between 4 and 7×10⁻⁴mbar and the pressure in the winding and unwinding chamber was about 9×10⁻² mbar. An aluminum layer of thickness between 30 and 40 nanometers was deposited onto the film, which was wound into a reel. The reel was taken out of the metallizer and heated with infrared heating just before unwinding.

The heating was from a constant infrared emitter that was placed at a 40 cm distance from the reel, and samples were taken at different speeds of unwinding in order to evaluate the influence of the thermal treatment on the barrier properties of the film. It was not possible to measure the temperature of the reel although it is believed that the maximum temperature could have been between 70° C. and 110° C.

After unwinding of the reel of metallized film produced in this manner, substantially 100% of the low temperature sealing composition Ctg2 was found to have transferred to the metal layer to produce a film of the present invention.

The properties of the metallized film were determined at various unwinding speeds, the speed indicated is the unwinding speed of the slitter, the higher the speed the lower the degree of heating of the reel.

| Unwinding | WVTR | Oxygen Transmission | |
|---|---|---|---|
| Speed m/min | g/m² per 24 hours | cc/m² per 24 hours | Resistivity |
| — | 3.76 | >2000 | 1.53 |
| 30 | 2.05 | 13 | 1.05 |
| 50 | 0.28 | 1.3 | 0.89 |
| 75 | 0.20 | 0.65 | 1.02 |

The films had a metal optical density of 2.5 to 3.0.

Resistivity is measured using a conductivity measuring apparatus type MTM 02 supplied by Hilberg of Alt Wachen Guchen 23, D 63477 Maintal, Germany.

The results indicate that at higher unwinding speeds and, thus, lower temperature the barrier properties are improved.

The printability of the 35-micron thick cavitated film prepared according to the previous Example was evaluated as follows. The film was corona-treated on the skin layer and in-line printed by gravure. The ink used was type S 8808 from Coates Lorilleux France, and around 0.8 g/m² of ink (weight after drying) was applied by gravure on 100% of the terpolymer surface of the film. The ink was dried at 50° C. in a thermal oven.

The film had the following structure:

Printed ink layer/corona treatment/skin layer based on terpolymer of polypropylene-ethylene-butylene/homopolymer layer/oriented layer of polypropylene cavitated and about 30 microns thick/layer of polypropylene grafted with maleic anhydride/layer of EVOH extruded and oriented/aluminum deposited under vacuum/low temperature sealing layer that has been transferred onto metal from the other side of the film. The anchorage of the ink on the corona-treated terpolymer was measured by applying a cellulose lithographic red 1129 from the company Scapa, the tape was removed at an angle of about 90° C. and no ink was removed by the tape showing good anchorage.

The sealability of the film was evaluated as follows. A reel of the printed film is put on a horizontal form fill and seal (HFFS) machine, type Record Super Jaguar. The machine direction jaws is transversal+Fin seal and the pack length 200 mm; the ink-to-ink coefficients of friction are 0.30 static and 0.23 dynamic. The coefficient of friction of the low temperature sealing layer is 0.50 static and 0.45 dynamic measured by slip peel tester TEC 450.

The film has good machinability as indicated by, no noise and no scratches when processed on the machine. The sealing range of the film of the invention, after transfer of the low temperature sealing layer onto the metal layer is similar to the sealing temperature range of a standard film without transfer when sealed under the same conditions. The sealing temperature range of a 35-micron thick film of the invention was compared with the sealing temperature range of a commercial 30-micron thick film (30 MW 648) and with the sealing temperature range of a commercial 40 micron thick film (40 MW 648). Both commercial films were coated with the same low temperature sealable coating and are supplied by ExxonMobil Chemicals Films Europe. The films were sealed in a Record Super Jaguar sealing machine with two pairs of jaws to form a 20-cm pack length. The film speed was 50 meters per minute and the minimum sealing temperature to obtain a seal strength of at least 300 g/25 mm was measured. A jaw temperature of 112° C. was required for the 30 MW 648 film, a jaw temperature of 143° C. was required for the film of the invention and a jaw temperature of 157° C. was required for the 40 MW 648 film. This shows that the 35-micron film of the invention has sealing properties between the commercial 30 and 40-micron films having the same sealable coating and thus shows that the sealing properties of the coating are retained after it is transferred according to the invention.

1. A multilayer film comprising:
i) a polymeric first layer having a first side and a second side;
ii) a polymeric second layer, the second layer having a first side and second side, the second side of the second layer on a first side of the first layer;
iii) a metal layer comprising a first side and a second side, the second side of the metal layer on the first side of the second layer; and
iv) a transfer layer having a debonded surface and a metal-bonding surface, the metal bonding surface fixedly engaged on the first side of the metal layer.

2. The multilayer film according to claim 1, wherein said transfer layer was formed on the second side of the first layer with the de-bonded surface of the transfer layer removably bonded on the second side of the first layer, and the transfer layer was thereafter transferred to and fixedly engaged on the first side of the metal layer following winding the film on a roll after the metal layer is applied to the second layer.

3. The film according to claim 1 wherein the transfer layer comprises at least one of a heat sealable layer, a barrier layer and a printable layer.

4. The film according to claim 1, wherein the debonded surface comprises an exterior surface of the film and is at least one of printable, sealable, and optionally may be laminated with another polymeric substrate.

5. The film according to claim 1 in which the first layer comprises a polyolefin having a melting point from 125° C. to 190° C.

6. The film according to claim 5 in which the polyolefin comprises at least one of polyethylene, polypropylene and polybutylene.

7. The film according to claim 5 in which the polyolefin comprises high density polyethylene.

8. The film according to claim 1 in which the polymeric second layer is coextruded with the first layer.

9. The film according to claim 1 in which the second polymeric layer comprises multiple layers.

10. The film according to claim 1 in which the transfer layer was formed on the second side of the first layer by one of coextrusion with the first layer, lamination to the first layer, or as a coating on the first layer.

11. The film according to claim 1 in which the transfer layer comprises a copolymer of ethylene and an unsaturated acid or ester.

12. The film according to claim 11 in which the unsaturated acid comprises acrylic and or methacrylic acid.

13. The film according to claim 11 in which the unsaturated ester comprises at least one of vinyl acetate, a C₁-C₄ acrylate or a C₁-C₄ methacrylate.

14. The film according to claim 1 in which the metal layer comprises aluminum.

15. The film according to claim 1 in which the metal layer is between 5 and 500 nanometers thick.

16. The film according to claim 1 wherein the multilayer film further comprises a post-transfer coating on the second side of the polymeric first layer, when the transfer layer is on the side of the metal layer opposite to the second layer.

17. The film according to claim 16 in which the post-transfer coating comprises at least one of a heat sealable layer and a printable layer.

18. The film according to claim 16 in which the coating is of 1) comprises at least one of a copolymer of ethylene and vinyl acetate 2) or a C₁-C₄ acrylate or 3) a C₁-C₄ methacrylate.

19. The film according to claim 1 further comprising at least one additional polymeric layer on the second side of the polymeric first layer.

20. The film according to claim 19, wherein the at least one additional polymeric layer comprises a heat sealable layer, a barrier layer and a printable layer.

21. A film according to claim 19 in which the heat sealable layer comprises a polyolefin of melting point from 5° C. to 50° C. lower than the melting point of the polymer of the first layer.

22. A film according to claim 1 wherein at least one of the second side of the first layer and the first side of the second layer is treated by one of chlorination, oxidation, heat, steam, corona, flame and plasma treatment.

23. A film according to claim 1 further comprising a primer applied to at least one of the first layer and the second layer.

24. A film according to claim 23 in which the primer selected from at least one of polyethylene imine, titanates, and reaction products of epoxy resin and an aminoethylated vinyl polymer.

25. The film according to claim 1 used to package an article.

26. The film according to claim 1 used to label an article.

27. An intermediary film comprising:
i) a polymeric first layer having a first side and a second side;
ii) a transferrable transfer layer having a first side and a second side, the first side of the transfer layer being detachably engaged on the second side of the first layer; and
iii) a metal layer having a first side and a second side, the second side of the metal layer on the first side of the first layer.

28. The intermediary film according to claim 27 wherein the transfer layer comprises at least one of a heat sealable layer, a barrier layer and a printable layer.

29. The intermediary film according to claim 27 further comprising a polymeric second layer between the first side of the first polymeric layer and the metal layer.

30. The film according to claim 27 in which the transferable transfer layer is

31. The film according to claim 27 in which the transfer layer comprises a copolymer of ethylene and an unsaturated acid or unsaturated ester.

32. The process according to claim 27 in which the transfer layer comprises water-based, solvent-based or solventless lacquers or inks, based on resins.

33. The film according to claim 27 in which the transfer layer comprises
i) a copolymer of ethylene and vinyl acetate, or
ii) a C₁-C₄ acrylate or
iii) methacrylate.

34. The film according to claim 27 in which the first layer comprises multiple layers.

35. The film according to claim 27 in which the metal layer comprises aluminum.

36. The film according to claim 27 in which the metal layer is an aluminum layer which is between 5 and 500 nanometers thick.

37. The film according to claim 27 further comprising a coating between the first layer and the transfer layer.

38. The film according to claim 27 further comprising an additional layer between the first layer and the transferable transfer layer.

39. The film according to claim 38 in which the additional layer comprises at least one of a heat sealable layer, a barrier layer, and a printable layer.

40. The film according to claim 27 farther comprising at least one additional layer on one or both surfaces of the first layer.

41. The film according to claim 40 in which the at least one additional layer comprises an extrudable polymer.

42. The film according to claim 27 further comprising a primer on at least one of
i) a surface engaged with the metal layer, and
ii) a surface of the metal layer.

43. The film according to claim 42 in which the primer comprises one of polyethylene imine, titanates, and reaction products of epoxy resin and an aminoethylated vinyl polymer.

44. The film according to claim 40 in which the at least one additional layer comprises an extrudable polymer having a melting point from 5° C. to 50° C. lower than the melting point of the polymer of the first layer.

45. The film according to claim 27 in which at least one of the first layer, the second layer and the transfer layer is treated by one of chlorination, oxidation, heat, steam, corona, flame and plasma treatment discharge treated on one or both of its surfaces.

46. The film according to claim 27 used to package an article.

47. The film according to claim 27 used to label an article.

48. A multilayer film comprising:
i) a polymeric first layer having a first side and a second side;
ii) a metal layer comprising a first side and a second side, the second side of the metal layer on the first side of the first layer;
iii) a transfer layer having a debonded surface and a metal-bonding surface, the metal bonding surface fixedly engaged on the first side of the metal layer;
wherein the transfer layer comprises one of a printable layer, a sealable layer and a barrier layer.

49. The multilayer film according to claim 49, wherein said transfer layer was formed on the second side of the first layer with the de-bonded surface of the transfer layer removably bonded on the second side of the first layer, and the transfer layer was thereafter transferred to and fixedly engaged on the first side of the metal layer opposite to the second layer upon winding the film on a roll after the metal layer is applied to the second layer.

50. The film according to claim 49, wherein the debonded surface comprises an exterior surface of the film and is at least one of printable, sealable, and optionally may be laminated with another polymeric substrate.

51. The film according to claim 49 in which the first layer comprises a polyolefin having a melting point from 125° C. to 190° C.

52. The film according to claim 49 in which the polyolefin comprises at least one of polyethylene, polypropylene and polybutylene.

53. The film according to claim 49 in which the polyolefin comprises high density polyethylene.

54. The film according to claim 49 in which the polymeric second layer is coextruded with the first layer.

55. The film according to claim 49 in which the second polymeric layer comprises multiple layers.

56. The film according to claim 49 in which the transfer layer was formed on the second side of the first layer by one of coextrusion with the first layer, lamination to the first layer, or as a coating on the first layer.

57. The film according to claim 49 in which the transfer layer comprises a copolymer of ethylene and an unsaturated acid or ester.

58. The film according to claim 57 in which the unsaturated acid comprises acrylic and or methacrylic acid.

59. The film according to claim 48 used to package an article.

60. The film according to claim 48 used to label an article.
